(19) United States
(12) Patent Application Publication
(10) Pub. No.: US 2005/0182870 A1
(43) Pub. Date: Aug. 18, 2005

(54) Wireline telemetry data rate prediction

(76) Inventors: Joseph M. Steiner JR., Sugar Land, TX (US); Lloyd D. Clark JR., Cedar Park, TX (US); Ramon Hernandez-Marti, Austin, TX (US); Soetjipno Chip Soetandio, Sugar Land, TX (US); Suzanne D. Richardson, Austin, TX (US)

Correspondence Address: SCHLUMBERGER CONVEYANCE AND DELIVERY;ATTN: ROBIN NAVA, 555 INDUSTRIAL BOULEVARD, MD-1, SUGAR LAND, TX, 77478, US

(21) Appl. No.: 10/780,013

(22) Filed: Feb. 17, 2004

(51) Int. Cl. G06G 7/48; G06F 3/00; G06F 3/05

(52) U.S. Cl. 710/60; 340/854.9; 703/10

(57) ABSTRACT

A wireline logging method including estimating a data rate requirement associated with a tool string to be connected to a wireline cable and determining an operating characteristic of a wireline cable at the surface. The operating characteristic is indicative of the wireline cable's data rate capacity. Before inserting the wireline cable into a well bore, a down hole value of the operating characteristic is modeled and a down hole data rate capacity is derived based thereon. Upon determining that the estimated data rate requirement does not match the down hole data rate capacity, the tool string is modified to remove or add tools to the tools string to match the tool strings data rate requirements with the estimated data rate capacity of the tool string and cable.

### BACKGROUND

1. Field of the Present Invention

The present invention generally relates to the field of data acquisition systems and more particularly to a wireline logging systems employing modular tool strings to acquire data where each module or tool in the tool string has its own data rate requirements.

2. History of Related Art

Wireline logging refers generally to the surveying of oil or gas wells to determine their geological, petrophysical, or geophysical properties using electronic measuring instruments. The electronic instruments are conveyed into a wellbore with a cable, referred to as a wireline cable. Measurements made by downhole instruments secured to the wireline cable are transmitted back to a data processing system located at the surface through electrical conductors in the wireline cable. Electrical, acoustical, nuclear and imaging tools are used to stimulate and measure the formations and fluids within the well bore. Telemetry instruments then transmit the digital data to the surface. The wireline cable also provides the electrical power needed to operate the logging tools.

In a conventional wireline system, a fixed data rate is specified for the telemetry system at the start of a logging job based on the requirements for the tools and the engineer's judgement. The specified data rate represents the maximum sustainable data rate at the existing environmental conditions. The existing environmental conditions typically means the conditions encountered at the surface of some existing or proposed well site whether on land or offshore. Then, once a cable is inserted in the well bore, the customer wants to begin taking meaningful data immediately because of the rig time expense associated with wireline logging.

Well bores may extend deep into the earth's surface where the environmental conditions existing at the end of a wireline cable will frequently differ dramatically from the surface conditions. Most notably, the temperature at the end of a well bore of any appreciable depth is almost certainly greater than the surface temperature. As the length of the cable increases and the temperature increases, the data capacity of the cable diminishes. In some cases, the capacity may decrease to a maximum sustainable data rate that is insufficient to support the equipment in the tool string. It would be desirable to implement a system and method for anticipating the down hole data rate prior to inserting the cable into the ground and for modifying the tool string to ensure that the tool string data rate requirements do not exceed the attainable data rate.

### SUMMARY OF THE INVENTION

The goal identified above is achieved with a wireline logging method including estimating a data rate requirement associated with a tool string to be connected to a wireline cable and determining an operating characteristic of a wireline cable at the surface. The operating characteristic is indicative of the wireline cable's data rate capacity. Before inserting the wireline cable into a well bore, a down hole value of the operating characteristic is modeled and a down hole data rate capacity is derived based thereon. Upon determining that the estimated data rate requirement does not match the down hole data rate capacity, the tool string is modified to remove or add tools to the tools string to match the tool string's data rate requirements with the estimated data rate capacity of the tool string and cable.

In various embodiments, determining the operating characteristic is achieved measuring the operating characteristic of the wireline cable as a function of frequency, determining the attenuation of the wireline cable, or determining the signal-to-noise ratio (SNR) of the wireline cable. Modeling the down hole value of the operating characteristic may be performed based on a linear temperature gradient assumption or based on a two-part temperature gradient assumption in which the temperature is constant or decreasing for a first part of the wireline and the temperature gradient is linear for a second part of the wireline.

### BRIEF DESCRIPTION OF THE DRAWINGS

Objects and advantages of the invention will become apparent upon reading the following detailed description and upon reference to the accompanying drawings in which:

FIG. 1 illustrates selected components of a wireline logging system suitable for use with the present invention;

FIG. 2 is a conceptual illustration of a borehole having at least one section that departs substantially from vertical;

FIG. 3 is a conceptual illustration of an offshore borehole;

FIG. 4 illustrates selected components of a wireline logging tool string suitable for use in connection with the present invention;

FIG. 5 is a graphical illustration of the change in characteristics of a wireline logging cable at two different temperatures;

FIG. 6 is a flow diagram of a method of anticipating the down hole data rate characteristics of a wireline logging system according to an embodiment of the present invention; and

FIG. 7 is a block diagram of selected elements of a system for determining the suitability of inserting a tool string into a well bore according to an embodiment of the invention.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the invention is limited only by the language of the appended claims.

### DETAILED DESCRIPTION OF THE INVENTION

Generally speaking, the present invention contemplates a wireline logging system and method in which the data rate characteristics of a wireline measurement tool are modeled to predict the characteristics of the tool at an anticipated temperature and depth. Typically, the anticipated temperature represents the temperature likely to be encountered down hole. Before inserting the tool into the well bore, action can be taken to reduce the data rate requirements of the tool string if the predicted characteristics suggest that the wireline will not be able to support the required data rate when the tool string is down hole. By engaging in this modeling, the invention eliminates the need for a potentially time consuming and costly trial-and-error procedure to determine if a given tool string will function properly down hole.

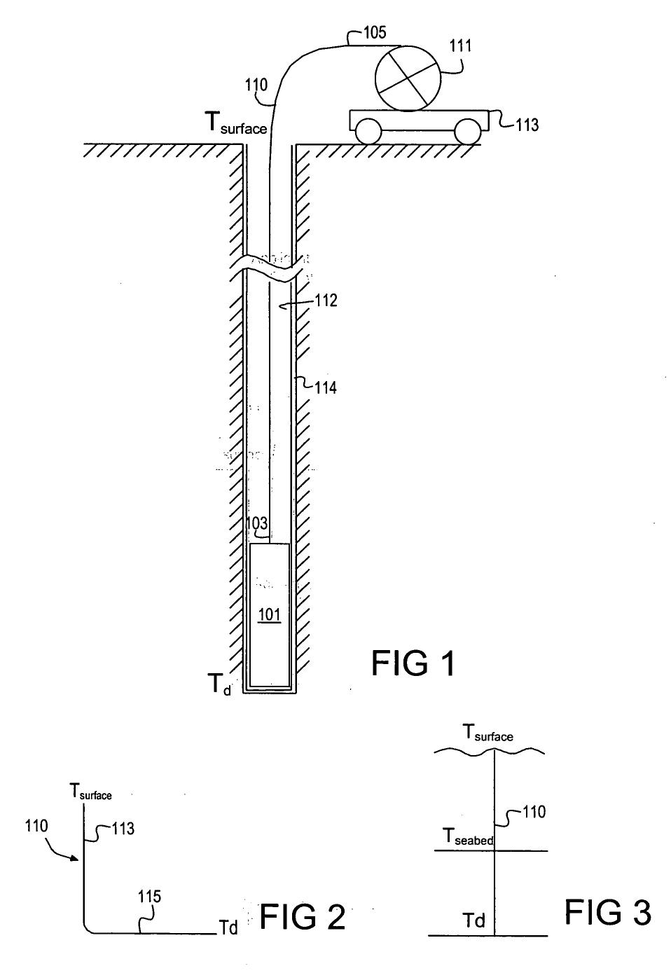

In FIG. 1, selected elements of a modular, wireline logging system 100 suitable for use in conjunction with the present invention are depicted. Wireline logging system 100 includes a tool string 101 connected to a distal end 103 of a wireline cable 110 that is inserted into a well bore 112. Casing 114 line may line some or all of the well bore 112. A proximal end 105 of wireline cable 110 is connected to a winch 111 positioned on a truck 113 at the surface of the well bore. The temperature at proximal end 105 of wireline cable 110 is indicated as T_{surface} and the temperature at distal end 103 of cable 110 (the down hole temperature) is indicated as T_{d}. Depths of well bore 112 may exceed 30,000 feet (9144 m). At such depths, the temperature T_{d} at distal end 103 of cable 110 is typically substantially higher than the temperature (T_{surface}) at proximal end 105.

In the depicted illustration, well bore 112 may be characterized as a substantially straight or linear well bore that is substantially vertical in orientation. This is a suitable accurate characterization for many actual well bores. In other cases, as depicted in FIG. 2 and FIG. 3, at least two other well bore orientations are likely to be encountered. These two particular orientations are explicitly illustrated because the assumptions regarding temperature gradient along wireline cable 110 that apply to the orientation of wireline cable in FIG. 1 are not accurately applicable to the orientations depicted in FIG. 2 and FIG. 3. In FIG. 2, for example, the wireline cable 110 includes a portion that is substantially horizontal or non-vertical with respect to the surface. This orientation is not uncommon because a horizontal well typically penetrates a greater length of the reservoir and can offer significant production improvement over a vertical well. Assumptions about the temperature gradient that apply to the vertical wireline cable of FIG. 1 must be revised when the actual wireline orientation is as shown in FIG. 2. Specifically, in one implementation, a linear temperature gradient is assumed for the substantially vertical wireline orientation of FIG. 1. In this implementation, the temperature T_{d} at the distal end 103 of cable 110 is measured or estimated when the well bore is first drilled or logged. The temperature profile is then assumed to be linear from T_{d} to T_{surface}. It will be apparent however, that the wireline orientation of FIG. 2 requires a different profile assumption because a substantial portion of the wireline is at temperature T_{d}. Thus, a linear temperature profile assumption would be unacceptably optimistic as applied to a wireline oriented as in FIG. 2.

The wireline orientation of FIG. 3 represents an offshore implementation where a significant portion of the cable 110 extends through a body of water before entering the earth at the seabed. In this orientation, a linear temperature profile would likely result in excessive constraints because the actual temperature profile would be less harsh than a linear profile. More than likely, the temperature would actually decrease from T_{surface} at the surface to a minimum temperature at the bottom of the sea. From there, the temperature profile would likely assume the linear increase model of the vertically oriented FIG. 1. As described in greater detail below, one embodiment of the invention incorporates algorithms enabled to perform wireline characteristic modeling based on one of these three basic orientations.

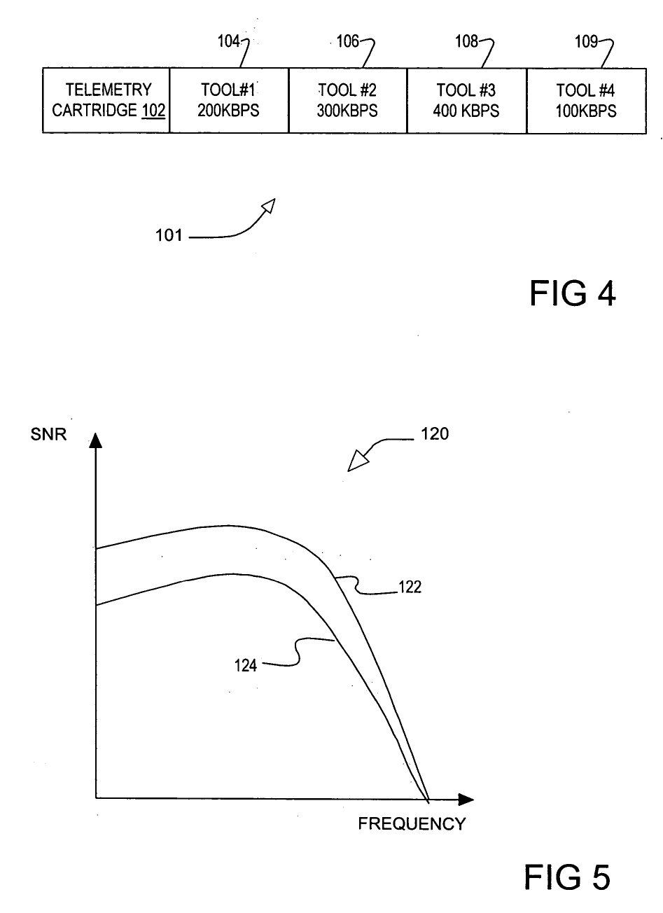

Turning now to FIG. 4, selected elements of tool string 101 are depicted. In the depicted embodiment, tool string 101 includes a telemetry cartridge 102 and a series of tools 104-109. The various tools 104-109 of tool string 101 may enable the measurement of formation properties such as electrical resistivity, density, porosity, permeability, sonic velocities, gamma ray absorption, formation strength and various other characteristic properties. Other tools may provide means for determining the flow characteristics in the well bore while still other tools include electrical and hydraulic power supplies and motors to control and actuate the sensors and probe assemblies. Generally, control signals, measurement data, and electrical power are transferred to and from the logging tool via the wireline. These and other logging tools are well known in the industry.

Telemetry cartridge 102 includes gathering and transmitting the well data generated by the various tools 104-109 to the surface via wireline cable 110. For at least two reasons, the data rate capacity of wireline cable 110 is subject to important minimum requirements. First, telemetry cartridge 102 is typically engaged in real-time data collection. In many instances, for example, data is being acquired as wireline cable 110 and tool string 101 move through a formation. If the data rate cannot support the real time acquisition of data, important data is lost. Moreover, higher data rates are required to reduce the amount of time that must be spent measuring or characterizing the formation. Wireline customers typically continue to incur rig time costs during the logging process, and these rig time costs may equal or exceed the cost of the wireline services. Customers, therefore, are very concerned with the amount of time required to characterize a formation. If the data rate is inadequate, more time will be required to characterize the well. This is especially true of data-intensive wireline logging services including, as examples, sonic and seismic logging services.

The desire to perform logging services in the shortest possible time has motivated the aggressive use of complex tool strings to acquire a wide variety of logging information with a single run in the well. Each tool in the tool string has its own data rate (also loosely referred to as bandwidth) requirements. As the number of tools included in a single tool string increases, it will be appreciated that the overall data rate requirements of the wireline system increases. As depicted in FIG. 4, fore example, tool string 101 includes a first tool 104 requiring a 200 kbps data rate, a second tool 106 requiring 300 kbps, a third tool 108 requiring 400 kbps, and so forth. For the depicted implementation, tool string 101 has a composite data rate requirement of 1000 kbps.

If the wireline cable system cannot support its required data rate down hole, one (or more) of the modules will be unable to transmit all of its data to the surface. Typically, the wireline cable would then have to be withdrawn from the well bore, the tool string would have to be modified such as by removing one or more modules to reduce the composite data rate requirement of the tool string, and the modified tool string would then be re-inserted into the well bore all at great cost and time to the customer. The present invention addresses this problem by identifying tool strings likely to encounter data rate problems down hole before those tool strings are put down hole. Conversely, an overly pessimistic projection of the down hole data rate may result in additional cost when unnecessary additional runs are required. In either case, the invention optimizes the tool string and wireline cable that are actually placed into the ground to the maximum sustainable down hole data rate.

The most significant variable affecting a wire line system's data rate capacity is temperature. In other words, while cable length, cable composition, and the type of tools attached to the cable will all affect the systems data rate capacity, these factors are substantially invariant once the tool string is defined. For a well bore of any significant depth, however, the temperature typically varies dramatically from the surface to the tool string. Thus, temperature differential between the surface and the terminus of a well bore is the primary reason that a wireline system that has a particular data rate capacity at the surface has a lower data rate capacity when down hole.

Referring to FIG. 5, an example relationship between temperature and the characteristics of a wire line system is illustrated graphically. More specifically, the signal-to-noise ratio (SNR) of a wire line cable is plotted as a function of signal frequency for two different temperatures. The first trace 122 represents data taken at a first temperature while the second trace 124 represents data taken at a second temperature where the first temperature is lower than the second temperature.

The use of SNR as the wireline system characteristic being plotted in FIG. 5, while not required, is highly desirable because (1) SNR is readily characterized using known techniques and (2) SNR provides a direct indicator of the system's data rate capacity. It is known that, for an additive white Gaussian noise (AWGN) system, C=B log₂(1+SNR) where C is the theoretical data rate capacity and wireline's B is the bandwidth. Assuming the system's bandwidth and modulation technique have been adequately characterized, a system's data rate capacity can be determined from its SNR. In FIG. 5, the SNR of a wireline system is plotted as a function of signal frequency at two temperatures. Not surprisingly, the SNR is higher throughout the frequency range at the lower temperature (trace 122). FIG. 5 also indicates that SNR delta, (the difference between lower temperature trace 122 and the higher temperature trace 124) is also a function of frequency. Whereas the SNR delta is relative stable or constant at lower frequencies, the delta is strongly frequency dependent at higher frequencies. The non-linearity of the relationship between SNR and temperature adds to the complexity of predicting the down hole data rate capacity of a given wireline system.

Portions of the present invention may be implemented as a set or sequence of computer executable instructions (i.e., software) that, when executed, enable a user to estimate the data rate capacity of a wireline logging system such as system 100. When being executed, the software may be stored in a volatile, computer-readable storage element such as computer's main memory (typically DRAM) storage or in an external or internal cache memory (typically SRAM) of a microprocessor or set of microprocessors. At other times, portions of the software may be stored in a non-volatile, storage element such as a hard disk, floppy diskette, CD ROM, DVD, magnetic tape, flash memory device, and the like.

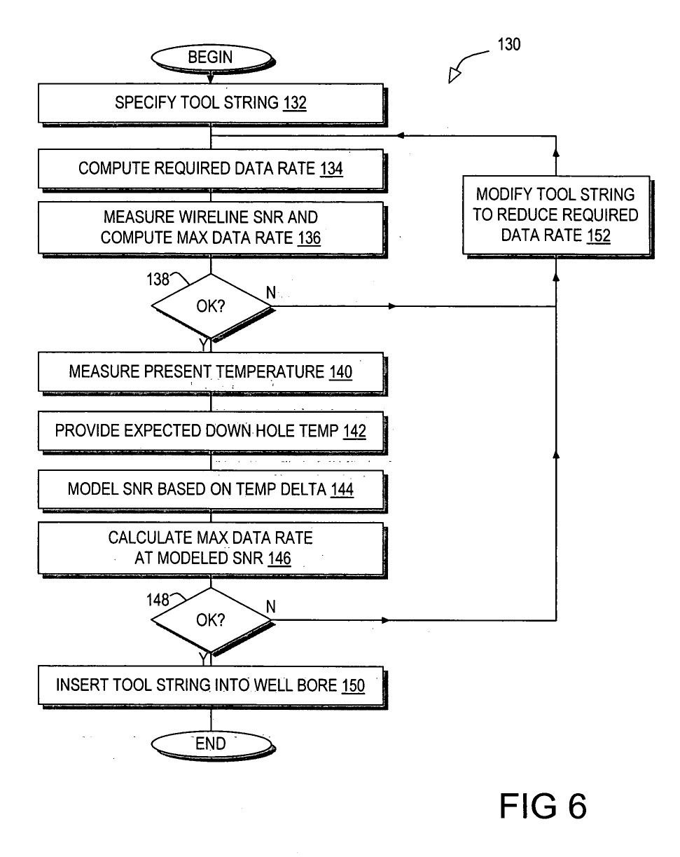

Referring now to FIG. 6, a flow diagram illustrates an embodiment of a method 130 for determining the suitability of a tool string for use in a well bore. Portions of method 130 may be implemented as or executed by computer software. Initially, a tool string is defined or specified (block 132) by an engineer. Specifying the tool string includes specifying not only the modules that are needed based on the measurements or data in which the customer is interested, but also the acquisition modes of those modules.

From the specified tool string a required data rate is computed (block 134). In one embodiment, the tool string is specified as a computer model in some form of hardware description language. Based on the described tool string, a computer program may determine the required data rate using archived empirical data, some form of heuristic determination method, or a combination of the two.

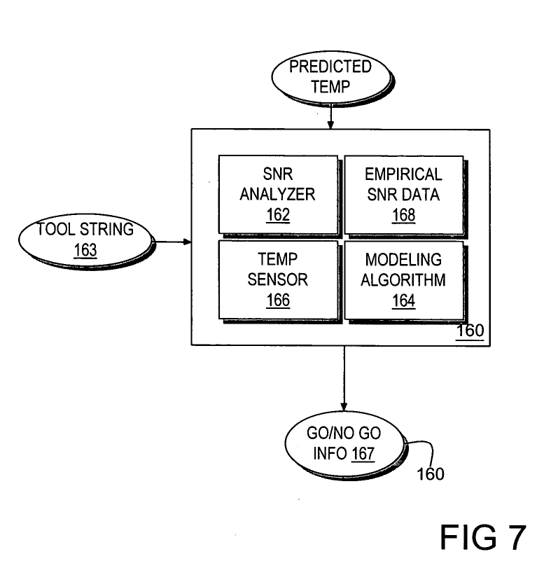

One or more characteristics of the actual wireline system are then measured (block 136) to enable the determination of the wireline's data rate capacity. In one embodiment, the measured characteristic(s) include the cables' SNR. The wireline measurement and characterization are typically performed at the well bore site before inserting the cable into the well bore. In one embodiment, a portable computer system (described in greater detail with respect to FIG. 7) which may be mounted on or otherwise attached to truck 113 (FIG. 1) facilitates the wireline characterization. In other implementations, the computer system is attached to or connected to an offshore logging cab or a portable system. The computer system includes software to calculate the data rate capacity based on the measured value of SNR.

The data rate capacity determined in block 136 is then compared (block 138) to the data rate requirement determined in block 134. If the required data rate exceeds the wireline system's data rate capacity, corrective action is taken by modifying (block 152) the tool string in a manner that reduces the system's data rate requirements. The required data rate and wireline data rate capacity could then be re-computed in block 134 and 136 until the system's data rate exceeds its required data rate.

Upon successfully exiting decision block 138, the present temperature (also referred to herein as the surface temperature) is provided (via, for example, user input) or measured (block 140) with a temperature sensor. An expected down hole temperature is then provided (block 142). The expected down hole temperature may represent an engineer's estimate of the maximum temperature likely to be encountered within a well bore or empirical data acquired when the well bore was drilled, or it may be the result from previous logging of the well or another well in the vicinity.

Using the surface temperature and the expected down hole temperature, analysis is performed, typically in software, to generate (block 144) a modeled value of SNR. This modeled value of SNR represents the system's estimate of the wireline system's SNR when located within the well bore. In one embodiment, the software or system responsible for modeling the SNR based on the two temperature values assumes a substantially linear temperature gradient from surface to well bore end. Under this assumption, the down hole expected temperature represents the temperature at the true vertical depth of the tool string 101. In this case, the linear temperature gradient that is assumed is generally acceptable for determining a modeled value of SNR.

In embodiments where the well bore is not substantially vertical and straight relative to the surface, alternative assumptions about the temperature profile along the cable must be made. Referring momentarily back to FIG. 2 and FIG. 3, the wireline profiles or orientations depicted therein require a different model of the temperature gradient. In FIG. 2, a first part 113 of wireline 110 is substantially vertical or perpendicular to the surface while a second part 115 of the cable is substantially horizontal or parallel to the surface. In this case, it is necessary to modify the linear temperature gradient assumption because the entire second part 115 of wireline is located at the true vertical depth and is presumably subjected to the same temperature T_{d}. Thus, the linear temperature gradient model used for the vertical wireline orientation would not account for the absence of temperature gradient along section 115. The SNR of a wireline exhibiting the orientation of FIG. 2 may be modeled using a two-part temperature profile assumption in which the second part 115 of wireline 110 is subjected to a constant temperature T_{d} while a linear temperature gradient is applied to the first part 113 of the wireline. In the offshore orientation of FIG. 3, the linear temperature gradient assumption is generally overly pessimistic because the portion of the wireline within the sea will generally experience an inverted temperature gradient. In other words, the temperature will decrease from the surface until it reaches a minimum at the sea bed. As the wireline penetrates the earth below the sea bed, the temperature begins to rise again. This type of orientation may be modeled using a theoretical temperature profile in which the surface temperate decreases linearly until a minimum is achieved at the sea bed at which point the temperature increases linearly until the down hole temperature is reached at the end of the wireline. Other embodiments of the invention may incorporate additional and/or more sophisticated temperature profile models, including combinations of these models. These three basic temperature profiles are explicitly illustrated because they represents three of the most common wireline orientations likely to be encountered in the field.

Returning now to the flow diagram of FIG. 6, the down hole wireline system is modeled to obtain an estimate of the wireline's operational characteristics based on factors including the system's characteristics as measured at the surface and the temperature profile assumed for the wireline. The modeling of the wireline system may include the use of tables of empirical data representing measured wireline characteristic data for various temperatures and wireline configurations. Such tables, for example, may include measurements of wireline cable characteristics that are normalized with respect to length at temperatures of 80, 85, and 90° C. and so forth. This information might represent historical data acquired within a field or lab site of a data logging services company such as Schlumberger. Modeling the down hole SNR would then include a process in which the wireline is modeled as a series of discrete sections, where each section is assumed to experience a single temperature. The historical data could then be applied to each of the theoretically discrete section to arrive at a composite model of the wireline. Other embodiments may employ algorithmic methods, including interpolation or extrapolation, to derive a theoretical value of the characteristic or characteristics of interest.

Upon modeling the down hole characteristics of the cable, a maximum sustainable down hole data rate is calculated (block 146) based on the modeled values of the wireline characteristics. If the characteristics include SNR, for example, the modeled SNR is used to determine a maximum down hole data rate.

The down hole data rate is then compared (block 148) to the data rate required for the defined tool string. If the tool string requires a higher data rate than the wireline can achieve down hole as determined by the wireline modeling, the engineer is informed and requested to modify the tool string in some way to reduce the required data rate. The required data rate could be reduced by, for example, removing one or more modules from the tool string, by altering their acquisition modes, or a combination of both. After modifying a tool string in response to an indication that the tool string will not be able to support its data rate down hole, the process of modeling the SNR or other characteristic(s) and determining a maximum, projected down-hole data rate, is repeated until the achievable data rate exceeds the data rate required by the tool string. It is also possible that the available data rate exceeds the tool string's requirements, allowing faster logging or the addition of one or more tools to the tool string.

Upon successfully determining that the achievable down hole data rate exceeds the data rate requirements of the defined tool string, the wireline system is inserted into the well bore (block 150). By modeling the wireline's data rate characteristics before placing the tool string down hole, the achievable data rate can be fully exploited and costly trial and error procedures, in which a determination that a tool string's data rate requirements cannot be supported is not made until the tool is in the well, can be minimized or avoided entirely.

FIG. 7 depicts selected elements of a system 160 for determining the suitability of placing a particular tool string down hole in a wireline logging operation. In the depicted embodiment, system 160 includes an SNR analyzer 162, a modeling algorithm 164, empirical data 168, and a temperature sensor 166. System 160 receives inputs in the form of a tool string definition 163 and an expected down hole temperature. In one embodiment, tool string definition 163 may include the data rate requirements of the tool string. In other embodiments, SNR analyzer 162 may calculate the data rate requirements of the defined tool string. The wireline orientation is assumed to be substantially vertical and the temperature profile may be assumed to be linear as discussed previously. In some embodiments, alternative temperature profile and wireline orientation may replace the default assumptions. In the depicted embodiment, the elements of system 160 operate on the inputs to produce information indicating whether the wireline system has sufficient down hole bandwidth to support the defined tool string.

The SNR analyzer 162 is configured to determine the SNR characteristics of the wireline cable, typically under relatively benign environmental conditions such as might be encountered at the surface of an offshore platform or a wellbore. SNR analyzer 162 determines the SNR characteristics for the wireline cable at various frequencies usually including all of the carrier frequencies employed by the telemetry cartridge. The temperature sensor 166 provides the surface temperature to the system. Based on the delta between the sensed temperature and the expected down hole temperature provided by the engineer, the SNR characteristics of the wireline are determine projected based using, in appropriate cases, modeling algorithm 164, empirical SNR data 168, or a combination thereof.

The information generated by system 160 may be as simple as a GO/NO GO indicator to a field engineer indicating that the currently defined tool string is likely to encounter data transmission problems unless modified. In other embodiments the information output from system 160 may include more detailed information about the tool string such as, for example, how much data rate is required for each individual tool string module, how much the required data rate exceeds the theoretical maximum data rate, and so forth. The analyzer may include facilities to modify itself by deleting or otherwise altering one or more modules that are contributing to the problem and re-running the modeling to determine if the wireline has sufficient bandwidth for the re-defined toolstring. Ultimately, however, the goal is to incorporate a relatively light weight or mobile computer system that is suitable for performing the system characterization processes described herein.

It will be apparent to those skilled in the art having the benefit of this disclosure that the present invention contemplates a wireline system in which the system's characteristics are modeled prior to going down hole in an effort to fully utilize the achievable data rate, allow faster logging and/or fewer runs, and reduce the amount of time spent reworking a tool string that cannot be supported. It is understood that the form of the invention shown and described in the detailed description and the drawings are to be taken merely as presently preferred examples. It is intended that the invention is limited only by the claim language.

1. A wireline logging method, comprising:
estimating a data rate requirement associated with a tool string to be connected to a wireline cable;
determining an operating characteristic of a wireline cable at the surface, wherein the operating characteristic is indicative of the wireline cable's data rate capacity;
before inserting the wireline cable into a well bore, modeling a down hole value of the operating characteristic and deriving a down hole data rate capacity based thereon; and
upon determining that the estimated data rate requirement does not match the down hole data rate capacity, modifying the tool string.

2. The method of claim 1, wherein determining the operating characteristic is further characterized as measuring the operating characteristic of the wireline cable.

3. The method of claim 2, wherein measuring the operating characteristic is further characterized as measuring the operating characteristic of the wireline cable as a function of frequency.

4. The method of claim 1, wherein determining the operating characteristic is further characterized as determining the attenuation of the wireline cable.

5. The method of claim 1, wherein determining the operating characteristic is further characterized as determining the signal-to-noise ratio (SNR) of the wireline cable.

6. The method of claim 1, wherein modeling the down hole value of the operating characteristic is further characterized as modeling the down hole operating characteristic based on a linear temperature gradient assumption.

7. The method of claim 1, wherein modeling the down hole value of the operating characteristic is further characterized as modeling the down hole operating characteristic based on a two-part temperature gradient assumption, wherein the temperature is constant for a first part of the wireline and the temperature gradient is linear for a second part of the wireline.

8. The method of claim 1, wherein modeling the down hole value of the operating characteristic is further characterized as modeling the down hole operating characteristic based on a two-part temperature gradient assumption, wherein the temperature is decreases with depth for a first part of the wireline and the temperature increases with depth for a second part of the wireline.

9. The method of claim 1, wherein modeling the down hole value of the operating characteristic includes accessing archived data of the operating characteristics of other wireline systems at various temperatures and deriving the modeled characteristic is based on the archived data.

10. The method of claim 1, wherein modifying the tool string comprises eliminating a tool from the tool string when the estimated data rate requirement exceeds the derived down hole data rate capacity.

11. The method of claim 1, wherein modifying the tool string comprises adding a tool to the tool string when the estimated data rate requirement is less than the derived down hole data rate capacity.

12. A system for optimizing a tool string assembly before inserting a wireline cable and the tool string assembly into a well bore, comprising:
an analyzer to determine a down hole value of an operating characteristic for the wireline cable wherein the operating characteristic is indicative of the cable's data capacity;
a modeler enabled to predict the down hole value of the operating characteristic when the wireline cable is inserted into the well bore;
means for indicating when a data rate corresponding to the predicted down hole value of the operating characteristic is not matched to a data rate required by the tool string.

13. The system of claim 12, wherein the analyzer is configured to measure the operating characteristic of the wireline cable.

14. The system of claim 13, wherein analyzer is further configured to measure the operating characteristic of the wireline cable as a function of frequency.

15. The system of claim 12, wherein the operating characteristic is further characterized as the attenuation of the wireline cable.

16. The system of claim 12, wherein the operating characteristic is further characterized as the signal-to-noise ratio (SNR) of the wireline cable.

17. The system of claim 12, wherein the modeler predicts the down hole value of the operating characteristic based on a linear temperature gradient assumption.

18. The system of claim 12, wherein the modeler predicts the down hole value of the operating characteristic based on a two-part temperature gradient assumption, wherein the temperature is constant for a first part of the wireline and the temperature gradient is linear for a second part of the wireline.

19. The system of claim 12, wherein the modeler predicts the down hole value of the operating characteristic based on a two-part temperature gradient assumption, wherein the temperature is decreases with depth for a first part of the wireline and the temperature increases with depth for a second part of the wireline.

20. The system of claim 12, wherein the modeler accesses archived data of the operating characteristics of other wireline systems at various temperatures and derives the modeled characteristic based on the archived data.

21. A computer-readable medium having a set of machine-executable instructions for optimizing a tool string for use with a wireline logging system, comprising:
computer code means for determining a data rate requirement for the tool string;
computer code means for modeling a down hole value of an operating characteristic of the tool string and its associated wireline cable; and
computer code means for estimating a data rate capacity of the wireline cable based on the modeled down hole value and for comparing the estimated data rate capacity to the determined data rate requirement and indicating when the estimated data rate capacity and the determined data rate requirement are mismatched.

22. The computer program product of claim 21, wherein modeling the down hole value of the operating characteristic is further characterized as modeling the down hole value of the wireline cable as a function of frequency.

23. The computer program product of claim 21, wherein the code means for modeling the down hole value are further characterized as code means for modeling the down hole value based on a linear temperature gradient assumption.

24. The computer program product of claim 21, wherein the code means for modeling the down hole value are further characterized as modeling the down hole value based on a two-part temperature gradient assumption, wherein the temperature is constant for a first part of the wireline and the temperature gradient is linear for a second part of the wireline.

25. The computer program product of claim 21, wherein the code means for modeling the down hole value of the operating characteristic are further characterized as modeling the down value based on a two-part temperature gradient assumption, wherein the temperature is decreases with depth for a first part of the wireline and the temperature increases with depth for a second part of the wireline.

26. The computer program produce of claim 21, wherein the operating characteristic is further characterized as the attenuation of the wireline cable.

27. The computer program product of claim 21, wherein the operating characteristic is further characterized as the signal-to-noise ratio (SNR) of the wireline cable.
